(19) United States
(12) Patent Application Publication
(10) Pub. No.: US 2003/0017440 A1
(43) Pub. Date: Jan. 23, 2003

(54) Methods for improving patient compliance with a treatment regimen

(75) Inventors: Todd David Bergey, Quakertown, PA (US); Richard Harold Romig JR., Souderton, PA (US); Charles Robert McLeester, Maddon Heights, NJ (US); Trevor Scott Feight, Easton, PA (US); Christopher Michael Matsinger, Wyncote, PA (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: THE PROCTER & GAMBLE COMPANY

(21) Appl. No.: 09/949,867

(22) Filed: Sep. 10, 2001

Related U.S. Application Data
(60) Provisional application No. 60/306,199, filed on Jul. 18, 2001.
(60) Provisional application No. 60/308,758, filed on Jul. 30, 2001.

(51) Int. Cl. G09B 23/28

(52) U.S. Cl. 434/262

(57) ABSTRACT

Methods for improving patient compliance with a treatment regimen intended to treat, prevent, cure or alleviate gastrointestinal disorders and diseases wherein the patient accesses a web page, selects a virtual guide, inputs data and receives customized e-mail messages in the style and tone of the virtual guide intended to motivate and educate the patient.

### CROSS REFERENCE

This application claims priority under Title 35, United States Code 119(e) from Provisional Application Serial No. 60/306,199, filed Jul. 18, 2001 and Provisional Application Serial No. 60/308,758, filed Jul. 30, 2001.

### FIELD OF THE INVENTION

The present invention relates to the field of on-line patient compliance programs and in particular to an on-line method for improving patient compliance with a treatment regimen for a gastrointestinal (GI) condition.

### BACKGROUND OF THE INVENTION

Patient compliance has been defined as “the extent to which an individual's behavior coincides with medical or health advice.” Remington's Pharmaceutical Sciences, Ch. 103, Vol. II, pg. 1796 (19^{th} ed. 1995). Compliance with therapy implies a positive behavior in which the patient is motivated sufficiently to adhere to the prescribed treatment because of a perceived self-benefit and a positive outcome (e.g., enhanced daily functioning and well being.) Id.

Most physicians assume that when they diagnose a medical condition and select a therapeutic agent and regimen for a patient to treat that condition, the patient will follow their recommendation and take the therapeutic agent according to instructions. However, patient compliance studies indicate otherwise. Studies indicate a high incidence of medication errors and non-compliance with respect to taking prescription drugs. See Stewart, R. B. et al, A review of medication errors and compliance in ambulant patients, in Clin. Pharm. Ther., 1972, vol. 13, 463-468.

Non-compliance with medical treatment regimens has been linked to over 125,000 deaths and several hundred thousand hospitalizations annually. The cost to treat medical problems associated with it has been estimated to range between $13 and $15 billion each year. Studies in 1992 showed that medication noncompliance was responsible for a loss of approximately 20 million work days, at a cost of more than $1.5 billion in earnings and $50 billion in lost productivity. The overall annual cost of these factors in the U.S. alone was estimated to exceed $100 billion, according to a 1992 report from the National Pharmaceutical Council. In addition, about 25% of nursing home admissions are the result of the patient's inability to take his or her medications correctly. See Eraker S. A., et al., Understanding and improving patient compliance, in Ann. Intern, Med. 100, 258(1984).

Noncompliance with drug therapy has also contributed to the development of drug resistant strains of viruses. This may render some drug therapies completely ineffective and calls for new therapies to combat variations of those previously known and treatable afflictions, thereby depleting research resources.

There are five main types of patient non-compliance with drug therapy. They are (1) the unwillingness to initiate therapy, (2) skipped doses, (3) discontinuation of therapy, (4) self-adjusted dosage, and (5) inappropriate drug administration. The first type of noncompliance involves a patient's unwillingness to initiate therapy. In this situation, a patient does not have the prescription filled due to embarrassment, stubbornness, denial of the disease or inability to pay for the medication. The second type of non-compliance involves the typically inadvertent skipped dose. Skipped doses may be the result of forgetfulness or confusing and complex drug regimens. Discontinuation of a drug due to intolerable side effects is another common type of noncompliance. Patients who are asymptomatic or fail to see expected results quickly may also discontinue drug therapy. The fourth type of noncompliance arises when the patient self-adjusts the frequency of dosage or dosage amount without consulting a physician. Self-dosing can lead to poor efficacy or toxicity of the prescribed medication. The last type of noncompliance is caused by inappropriate drug administration typically caused by a lack of patient education concerning the appropriate use of the prescribed drug.

Methods to improve medication compliance have been studied since the 1970s. One of these early studies, conducted by J. M. McKenney et al., and published in Circulation in 1973, evaluated the effect of pharmacist interventions on medication compliance in patients with hypertension. The results of this study revealed that patients regularly seen and counseled by pharmacists were more compliant to drug therapy and had better overall control of blood pressure compared to those who had no interaction with a pharmacist. But, upon study completion (and discontinuation of pharmacist interaction), follow-up assessment indicated that study patients reverted to their pre-study status of poor blood pressure control. This outcome was theorized to be directly correlated to the cessation of pharmacist interaction. This relationship with the pharmacist provides encouragement to adhere to the treatment regimen prescribed, education about the disease, the medication and the potential effects of non-compliance and also serves to remind patients to have their prescriptions refilled.

Compliance/adherence programs should attempt to emulate the pharmacist-patient relationship by “provid[ing] patients with information to enhance their understanding of both their medications and disease states in order to promote better health outcomes through compliance to prescribed treatment regimens”. Id. However, compliance/adherence programs should not act as a replacement for the pharmacist or doctor but should merely supplement and follow-up from the patient-pharmacist or patient-doctor relationship.

Over the years a number of compliance methods and devices have been created in an effort to reduce noncompliance with drug therapy. These range from simple pill boxes, alarm devices, postcard reminders, medication calendars and coupon or voucher reward systems to the highly sophisticated automated medication dispensing devices that can be networked between patient, healthcare provider and pharmacist. While these tools may be useful to help the forgetful patient, the unmotivated patient needs additional encouragement in the form of education support and advice from a “fellow sufferer”.

This need for encouragement and support is especially true for patients with GI diseases and disorders. While these patients exhibit characteristics typical of any chronic long-term disease sufferer, often times there is an element of embarrassment that accompanies such conditions. Fear and anxiety play key roles in how and whether these patients cope with their illness in a productive, adaptive way, or whether they deal with it defensively and less realistically. The vast majority of patients fall somewhere along a continuum between adaptive and defensive behavior, using whatever coping mechanism or combination of mechanisms “works for them” depending on whether they have a compliant or non-compliant personality. There is a need to provide motivation and encouragement to patients with GI diseases and disorders to increase compliance with a treatment regimen.

### SUMMARY OF THE INVENTION

The present invention relates to methods for improving patient compliance with a treatment regimen for a gastrointestinal condition wherein a patient accesses a web site which offers a selection of “virtual guides” from which the patient chooses his or her own personal guide. The guides are not real persons but are actually patient composites whose stories and personal history involve issues surrounding management of gastrointestinal (GI) related diseases and disorders. The “virtual guide” is a computer generated composite of an experienced patient, specifically a fellow sufferer of the same disease or disorder as the patient-user, with whom the patient-user receives information from, as well as encouragement and tips for coping with the disease. After selection of the virtual guide the patient submits information via a forms-based questionnaire including, but not limited to, data relating to his or her current disease state, the treatment regimen prescribed, the length of time since the onset of the disease, the patient's attitude towards his or her treatment regimen, demographic information of the patient, and his or her need for support, motivation, and education. The data requested may vary depending on the type of GI disease or disorder to be treated or the complexity of the disease or treatment regimen, as well as other factors which may affect the frequency or content of the electronic communications. Following submission of the data, a communication relationship begins wherein tailored electronic messages, or “e-mails”, written in the “style and tone” of the selected guide, are sent to the patient. The style and tone of the virtual guide is typically reflected in wording choices and may convey the attitudes of the guide, regional dialect or language, educational level of the guide, or generational differences, as well as other personality and behavioral variations. E-mails are sent at a predetermined frequency that varies according to patient entered data. In one embodiment the frequency of e-mail communications varies according to the patient's experience with the disease and his or her disease state as described within the data inputted by the patient. In one embodiment requests for the submission of additional data relating to the patient's symptoms, personal history, interests, and other relevant information, continue throughout the relationship in order to increase the level of personalization and continuously tailor the e-mail communications to the patient's changing needs. These additional forms-based questionnaires may be accessed through a link supplied within the e-mail communications sent to the patient-user or may be included or attached within the e-mail itself. Data submitted by the patient-users may be manipulated or tracked, optionally anonymously, for research purposes.

### BRIEF DESCRIPTION OF THE DRAWINGS

FIG. 1 is a block diagram illustrating the main components of a system utilized by the present invention and the interaction among those components.

FIG. 2 is a process flow diagram, or functional site map, of a method of the present invention illustrating the steps of patient registration and the selection of a “virtual guide”, as well as the necessary steps for updating a patient profile.

FIG. 3 is a process flow diagram of one embodiment of the present invention illustrating the comparison of answers to a forms-based questionnaire to a frequency matrix in order to determine the schedule for sending to patient-users electronic messages.

FIG. 4 is a matrix depicting the various personality types and the coping techniques employed by patients of each category when dealing with a long-term chronic disease or disorder.

### DETAILED DESCRIPTION OF THE INVENTION

The present invention relates to an on-line method for improving patient compliance with a treatment regimen for gastrointestinal diseases and disorders wherein a patient accesses a web site which offers a selection of “virtual guides” of varying age, sex, race, marital status, location of residence, personality traits, education and socio-economic backgrounds, and various types and length of experience with the specific gastrointestinal disease or disorder. The number of guides available to the patient depends on the complexity of the GI disease and/or treatment regimen, the length of treatment, the total number of users, etc. There is no limit to the number of virtual guides that may be offered to the patient. The patient selects his or her own virtual guide from those guides available and submits personal data relating to his or her own disease state, interests, personality, and biographical information. Customized e-mails capturing the style and tone of the selected guide are sent to the patient at a predetermined frequency. The messages are motivational in nature and intended to enforce the importance of adherence to the treatment regimen or drug therapy.

An on-line method for increasing patient compliance with a treatment regimen that is designed to treat, prevent, cure or alleviate gastrointestinal disorders or diseases comprising a patient-user afflicted with the gastrointestinal disease or disorder conducting the steps of: accessing a web page providing a selection of virtual guides with varying physical characteristics and personality traits from a remote interface via a remote network, selecting a virtual guide by choosing the appropriate link entitled “Choose Me”, or the like, when reviewing the guide profiles, inputting personal data, and receiving computer generated informational and motivational electronic messages composed in the style and tone of the virtual guide.

The present invention also relates to an automated, on-line method for increasing patient compliance with a treatment regimen that is designed to treat, prevent, cure or alleviate gastrointestinal disorders and diseases comprising the steps of:

(a) providing a web page for a patient to access from a remote interface via a remote network wherein the patient is prompted to choose a virtual guide from a selection of virtual guides,

(b) transferring to the patient a forms-based questionnaire wherein the patient is requested to submit personal data,

(c) generating an informational and motivational electronic message composed in the style and tone of the patient's selected virtual guide, and

(d) transferring the electronic message to the patient.

The present invention also relates to an automated, on-line method for increasing patient compliance with a treatment regimen that is designed to treat, prevent, cure or alleviate gastrointestinal disorders and diseases comprising the steps of: storing virtual guide profiles in a centralized database housed on a database server for access by a patient-user from a remote interface via a remote network, transferring virtual guide profiles to a remote interface for review by the patient-user, receiving a virtual guide selection made by the patient-user, generating one or more electronic messages wherein the electronic message is composed in the style and tone of the selected virtual guide, and transferring one or more electronic messages to the patient-user.

The present invention also relates to an automated, on-line method for increasing patient compliance with a treatment regimen that is designed to treat, prevent, cure or alleviate gastrointestinal disorders and diseases comprising the steps of:

(a) storing virtual guide profiles in a centralized database, housed on a database server, for access by a patient-user from a remote interface via a remote network,

(b) transferring virtual guide profiles to a remote interface for review by the patient-user,

(c) receiving a patient-users's selection of a virtual guide,

(d) transferring to the patient-user a forms-based questionnaire for inputting personal data for determining a patient-user's personality type and frequency schedule for electronic messages to be sent to the patient-user and providing customization to the electronic messages,

(e) receiving answers to the forms-based questionnaire entered by the patient-user,

(f) storing the answers to the forms-based questionnaire in the centralized database,

(g) evaluating the answers to the forms-based questionnaire and comparing the answers to a personality matrix to determine the personality type of the patient-user,

(h) evaluating the answers to the forms-based questionnaire and comparing the answers to a frequency matrix to determine the appropriate frequency schedule for sending electronic messages to the patient-user,

(i) generating one or more electronic messages wherein the electronic messages are in the style and tone of the selected virtual guide and the content is based on the patient-user's answers to the forms-based questionnaire,

(j) transferring one or more electronic messages to the patient-user via a message delivery means, and

(k) storing the content of the electronic messages in the centralized database.

The terms “gastrointestinal diseases and disorders” and “gastrointestinal conditions” as used herein include, but are not limited to, the following afflictions, gastroesophageal reflux disease (GERD); inflammatory bowel disease (IBD); irritable bowel syndrome (IBS); ulcerative colitis (IC); Peptic Ulcer Disease, which includes gastritis, gastric ulcer, duodenitis, and duodenal ulcer; gastric cancer, colon cancer, dysphagia, heartburn, constipation, diarrhea, diverticulitis, diverticulosis, Crohn's disease, achalasia, intestinal lactase deficiency, Zollinger-Ellison syndrome, esophagitis, polyps, and dysplasia. In one embodiment, the gastrointestinal diseases and disorders are inflammatory bowel disease, irritable bowel syndrome, ulcerative colitis, Crohn's disease and combinations thereof.

The term “treat” as used herein means, at a minimum, prescribing a drug therapy or other regimen that mitigates a disease or disorder in a mammalian subject, preferably in humans. Thus the term “treat” includes: preventing a disease or disorder from occurring in an mammal, particularly when the mammal is predisposed to acquiring the disease or disorder, but has not yet been diagnosed with the disease or disorder; inhibiting the disease or disorder and/or alleviating or reversing the disease or disorder.

The term “prevent” as used herein refers to the ability of the skilled artisan to identify a population that is susceptible to diseases and disorders, such that the prescribing of a drug therapy or other regimen may occur prior to the onset of the symptoms of the disease or disorder. For example, both environmental and genetic factors have been implicated in causing colon cancer. Risk factors include low dietary fiber intake, high animal fat consumption and an incidence of colon cancer in close family members. In addition the elderly population is at increased risk for colon cancer. Thus, potential members of the patient population are identifiable and could receive prescribed drug therapy and other regimens before progression of the disease. Progression of the disease in such individuals could be “prevented” in this manner. It should be understood that the term “prevent” as used herein does not require that a disease or disorder be completely thwarted.

The Operating System

The methods to increase patient compliance utilize a system, which includes a server and a remote interface, for the patient to input data. The server is typically a web server and the remote interface a personal computer or remote terminal connected to the server via the Internet.

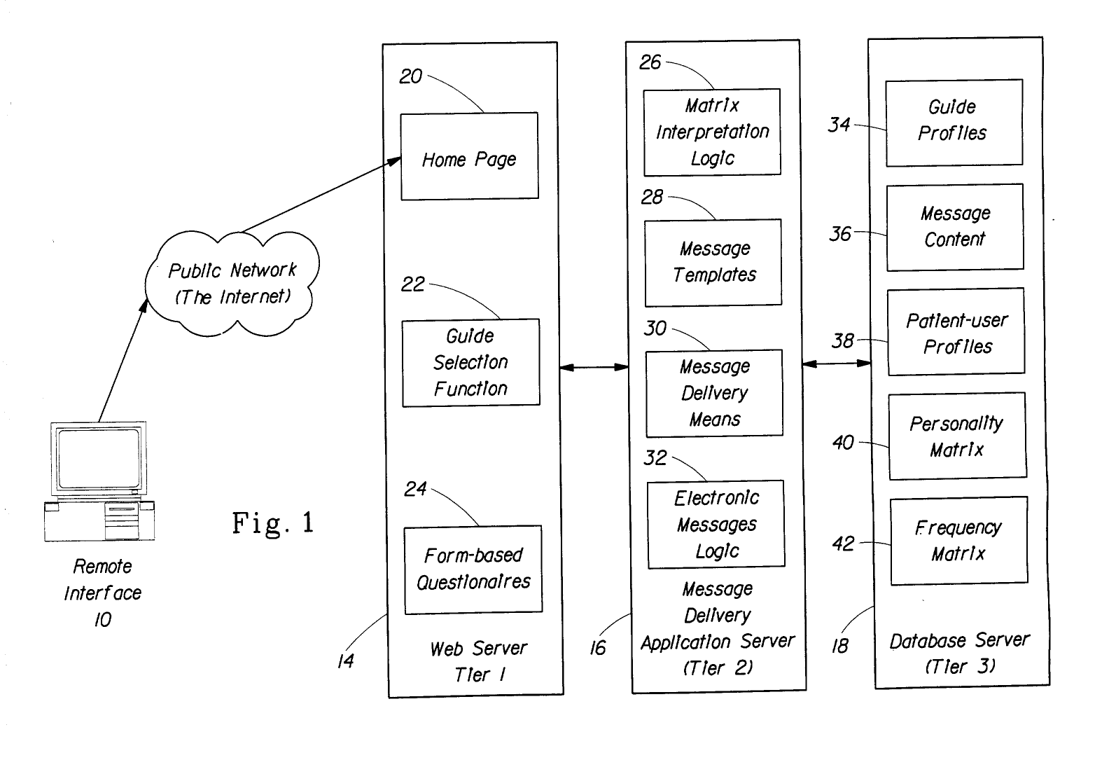

FIG. 1 is a block diagram of one embodiment of the present invention illustrating the main components of a system utilized by the present invention and the interaction among those components. The remote network is a public communication network 12 such as the Internet or public telephone network. The remote interface 10 utilized by the patient-user is connected to the public communication network 12 through the use of a modem or local area network. In another embodiment, in addition to patient-users, healthcare providers, pharmacies and managed care organization may connect to the public communication network 12 through another remote interface 10 and access the web page 20. Of course, many other types of communication networks and connections to the communication networks may be employed without departing from the scope of the invention. Specific techniques for networking computer systems for on-line interaction are well known in the art.

In one embodiment the remote interface 10 is a personal computer at the patient's home which comprises aggregation, processing and display means. The keyboard of the personal computer is an input and allows the patient to input personal data into a forms-based questionnaire when prompted. In one embodiment other inputs may be used with the system, for example, a heart monitor or other monitoring device. Additional inputs may be at a remote location and in communication with the computer over a remote network. A Hypertext Markup Language (HTML) page, or web page, 20 provides the patient access to the web server.

Once the patient has accessed the web page 20, the information stored within the database server 18 is accessible via the message delivery application 16. The database server 18 houses the guide profiles 34, all patient-entered data and generated patient profiles 38, the personality matrix 40, the frequency matrix 42, and the electronic message content 36. The message delivery means 30 resides on the message delivery application server 16, which also contains the message templates 28 and the electronic message logic 32 for assembling the electronic messages, as well as the matrix interpretation logic 26 that interprets the personality matrix 40 and the frequency matrix 42 for a particular patient. The patient data is entered via a forms-based questionnaire 24 that is transferred to the remote interface 10 after the guide selection function 22 is successfully completed.

When patient information is entered it is categorized into one of several personality categories by comparison to the personality matrix 40 using the matrix interpretation logic 26 to determine the appropriate content of the e-mail communications. The data will then be compared to the frequency matrix 42 using the matrix interpretation logic 26 to determine the appropriate e-mail communication schedule. The message delivery means 30 will then generate and send e-mails to the patient-user with the voice and tone of the selected guide using the electronic message logic 32 and the message templates 28.

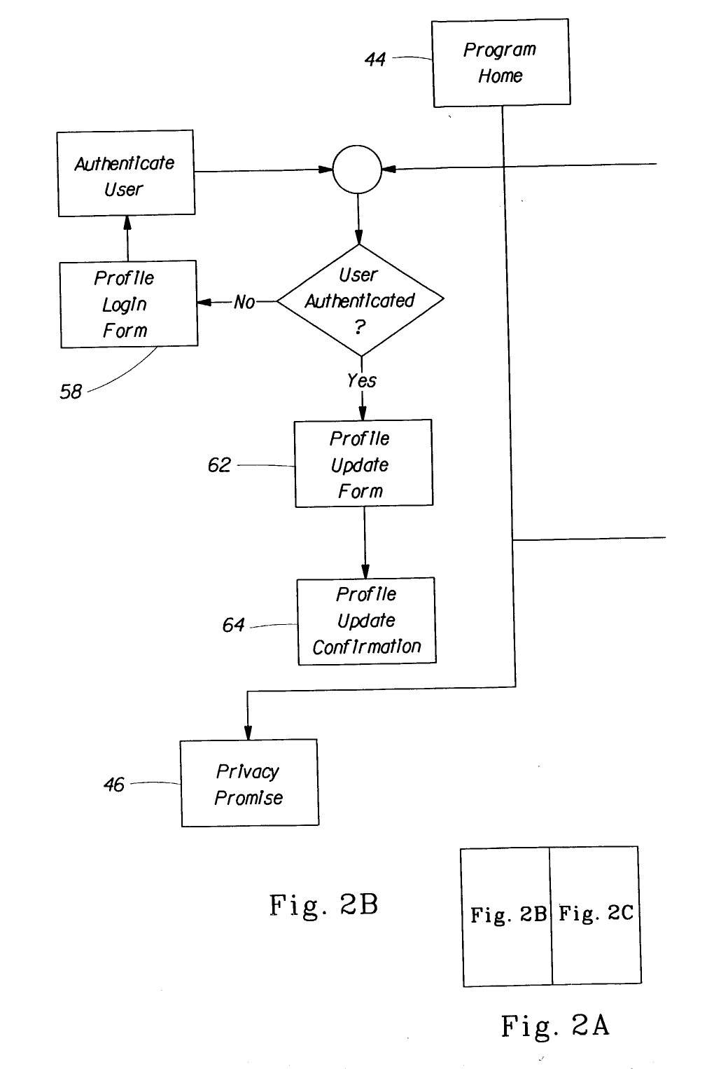

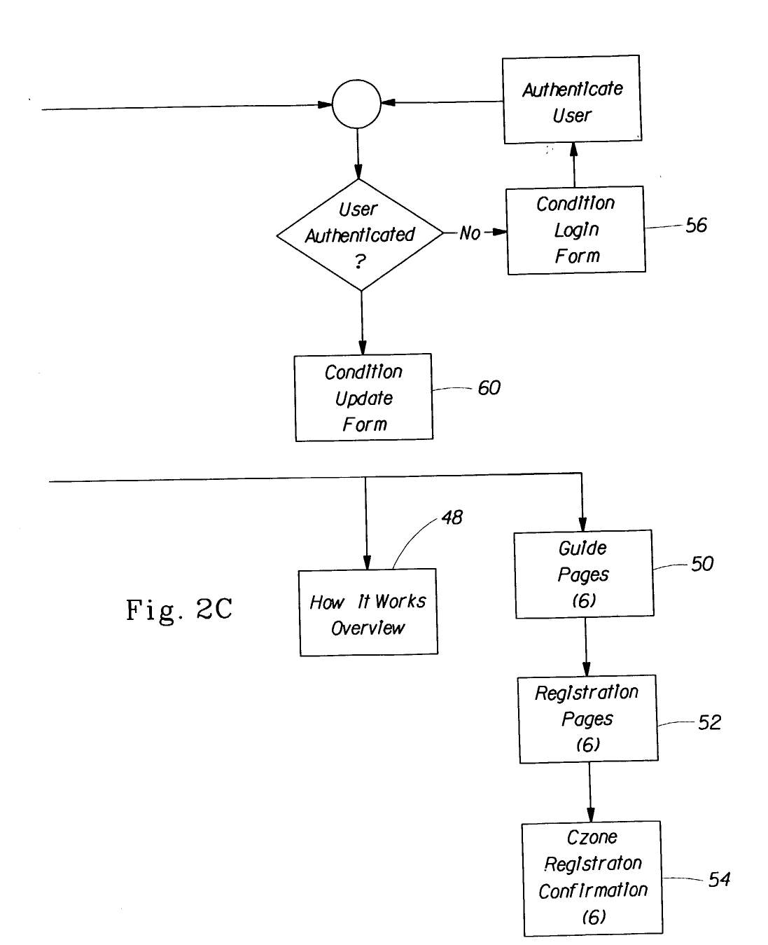

FIG. 2 is a process flow diagram, or functional site map, illustrating the options available to the patient from the program home page 44. From here the patient may view the privacy notice 46, update his or her patient profile, update his or her condition, read an overview 48 of the program or view the guide profile pages 50. From the guide profile pages 50, the patient may select a virtual guide from the registration pages 52.

Patients will receive a confirmation page 54 upon successful completion of the registration and selection process.

Once a user has registered on the site, all information will be captured and a patient profile will be created with a unique UserID and Password. The responses to the forms-based questions captured at registration are used to determine the communication track that the user will be on. Three components make up the communications track; the frequency schedule assigned, the personality type assigned and the guide selected. The patient-user will receive e-mail sent via the message delivery means, with a set frequency, content and style that correlates to the assigned communications track. In one embodiment further customization of the e-mail messages is achieved through additional forms-based questionnaires that are included within, attached to or linked to the electronic messages that the patient-user receives. The information entered by the user will be stored in the patient profile on the database server.

Users may return to the registration site to update information in their patient profile, change guides, and/or indicate a change in their condition. When a patient-user wishes to access the profile update form 62 or the condition update form 60 the user must first be authenticated. Users may be required to log in with a UserID and password in a profile login form 58 or a condition login form 56, prior to gaining access to the profile update form 62 or the condition update form 60. Where UserIDs and passwords are not employed, an alternate form of identity verification can be used.

The Frequency Matrix

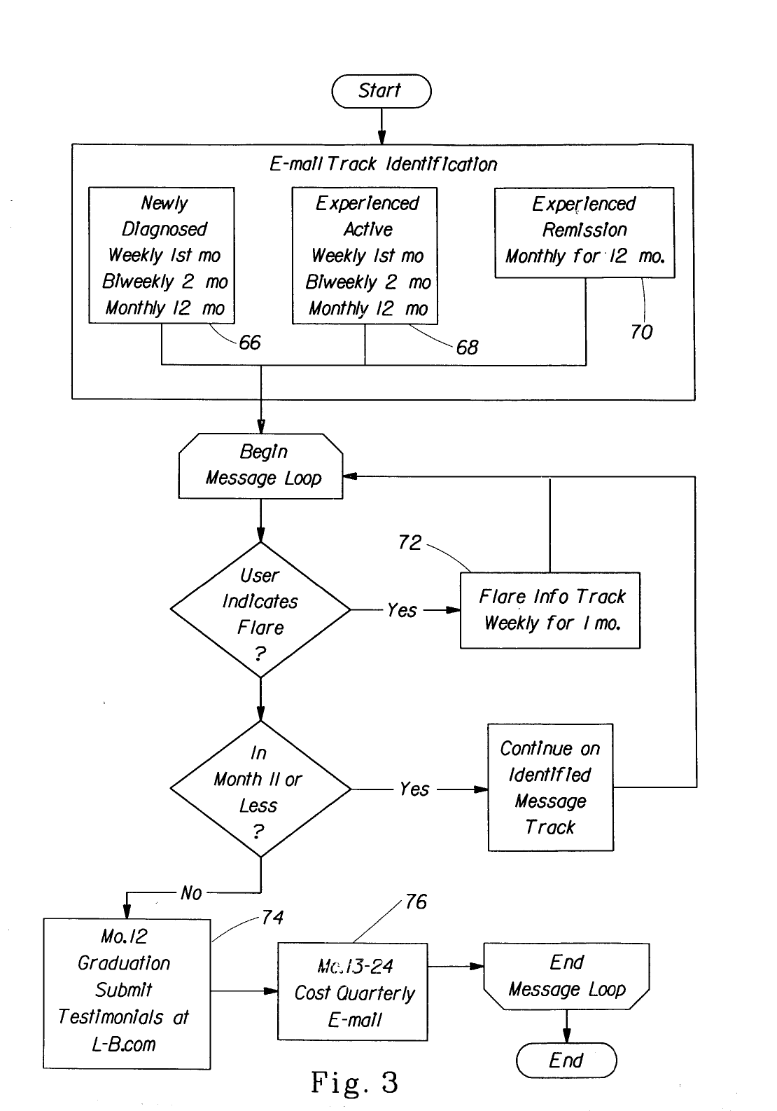

In determining the frequency schedule of the e-mail communications patient-user entered data disclosing his or her experience with the disease and the current disease state, is compared to a frequency matrix. FIG. 3 is a process flow diagram of one embodiment of the present invention illustrating the comparison of answers to a forms-based questionnaire to a frequency matrix in order to determine the schedule for sending to patient-users electronic messages.

The frequency of the e-mail communications can vary from patient to patient. Typically the frequency is determined based on the disease type, the patient's personal history with the disease and the patient's then current disease state. Other factors can be used to determine the frequency of e-mail communications to ensure the needs of the patients are being met including, but not limited to, the educational needs of the patient, length of time since the disease onset, the age of the patient and the complexity of the treatment regimen prescribed. In one embodiment, patients are divided into three categories; experienced with disease and active 68; experienced with disease but in remission 70; and newly diagnosed with the disease and, therefore, active 66.

In one embodiment, those newly diagnosed 66 with the disease and in an active disease state receive frequent communications, weekly for the first month, biweekly for the second and third months and then monthly. Those patients experienced with the disease but in an active disease state 68 receive communications on the same frequency as newly diagnosed patients but with differing content reflecting their experience with the disease. Those patients experienced with the disease but in remission 70 will receive less frequent, less urgent e-mails approximately once a month. These patients may need to be educated and reminded as to the importance adhering to the drug regimen as prescribed in order to avoid recurrence of symptoms. Once a patient-user has been categorized into the frequency matrix, the schedule will continue for a set period of time. In one embodiment, the frequency schedule continues for one year and the patient then “graduates” 74. Some deviations from the preset frequency schedule may occur. In one embodiment, where a patient has updated his or her condition profile to indicate that he or she is in a newly active disease state (for example an Ulcerative Colitis flare up condition has occurred) the e-mail communications may follow a new frequency schedule for a set period of time or until the time that a patient indicates the flare up has passed. In one embodiment, upon completion of the 12 month program, another year of quarterly e-mail communications 76 follows. The frequency matrix and schedule can vary greatly depending on the disease or disorder involved, the complexity of the treatment regimen and the projected or actual length of treatment and other factors that may affect the need for communication.

The Personality Matrix

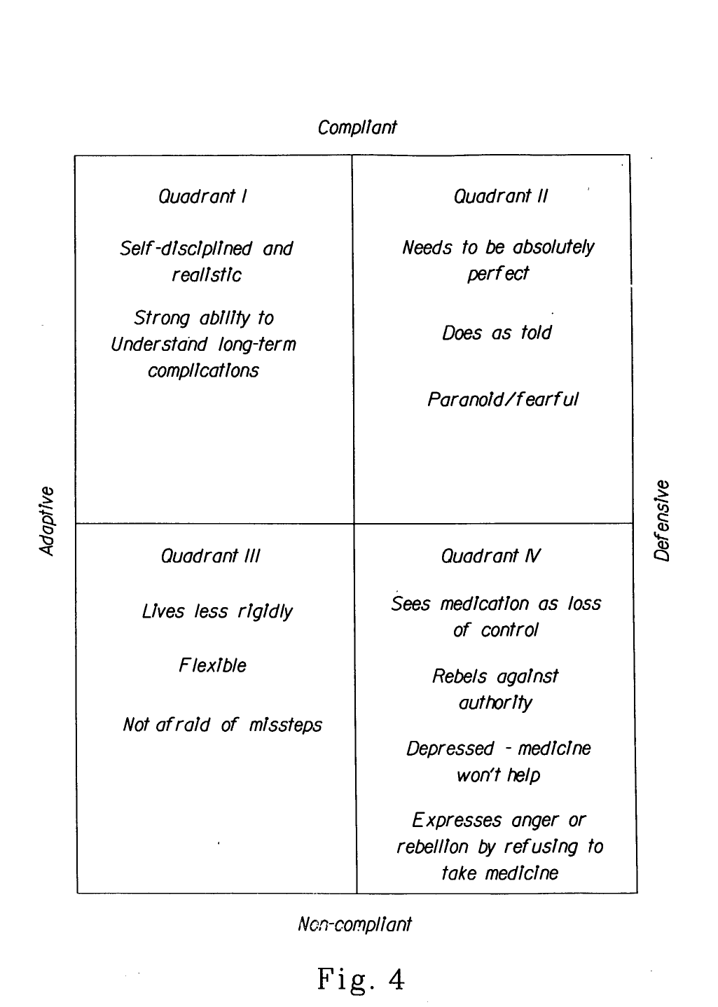

Because it is difficult to truly understand each individual patient's personality types and coping strategies, it is important that all patient communications be crafted with an understanding and consideration of the various coping mechanisms that patients demonstrate according to their personality types. FIG. 4 is a matrix that depicts the various personality types and the coping techniques typically demonstrated by sufferers of long-term chronic disease. Quadrant I represents the Compliant/Adaptive patient and describes him or her as self-disciplined and realistic in his or her views about the disease. Quadrant II displays characteristics of the Compliant/Defensive patient who shows signs of fear and paranoia, which may prompt the patient to adhere to a prescribed treatment regimen. These patients often insist on perfection and may find it difficult to deal with variations in routine, such as traveling. Quadrant III describes the Non-compliant/Adaptive personality. This patient may not be concerned with strict adherence to a treatment regimen but is flexible and open to change. Quadrant IV shows the Non-compliant/Defensive patient. This patient is least likely to adhere to drug therapy. The patient may be angry or suspicious of authority and may refuse drug therapy, which he or she may perceive as a loss of control. This patient is often depressed and fails to see the benefits that may be achieved with drug therapy. E-mail communications sent to the patient-user are designed to address the varying needs of the different personality types.

Answers entered by a patient user via a forms-based questionnaire are compared to this matrix and a personality type is assigned. This personality type, in conjunction with other patient inputted data, determines the content of the electronic messages sent to the patient-user.

The Virtual Guide

The term “virtual guide” as used herein refers to a computer generated patient composite who serves as a mentor for the patient-user. Each patient composite is based on actual stories and personal histories of people diagnosed with and living with various gastrointestinal diseases and disorders. The virtual guide is designed to be a fellow sufferer of the GI condition, offering unique insights into coping with the disease or disorder on a daily basis. Each virtual guide possesses a unique ‘personality’ and is assigned specific character traits and biographical statistics. Personality is defined as the unique organization of traits, characteristics and modes of behavior of an individual, setting the individual apart from others and at the same time determining how others react to the individual. Taber's Cyclopedic Medical Dictionary, 18^{th} ed., F. A. Davis Company, 1452 (1997). While these traits, characteristics and modes or behavior vary greatly from individual to individual, the virtual guides are designed to emulate some common personality traits. The virtual guides may vary based on a number of character and personality traits including, but not limited to, age, gender, race, career, family and marital status, location of residence, favorite hobbies and general likes and dislikes. There is no limit to the number of virtual guides that may be offered to patient-users.

Upon accessing an informational website, typically associated with the GI condition that the patient is diagnosed with, the patient will “click on” or otherwise select a link that will allow them to choose a guide from a group of those virtual guides available from whom the patient will receive continuing e-mail communications. Each guide is described through a short written biography or profile. In one embodiment, the biography includes information as to the guide's likes and dislikes, the guide's reaction to hearing his or her own diagnosis with the GI disease of disorder, the guide's current state of health and feelings about the disease and some advice or “words of wisdom” from the fellow sufferer to the program participant. The patient is able to read the biography or profile of each guide, typically by ‘clicking’ on the virtual guide name or photo. After reviewing the information provided, the patient selects a guide by clicking a link at the bottom of the web page, entitled “Choose Me” or a similar phrase indicating selection of the specific guide is intended.

In one embodiment, the virtual guides are represented by a photo or a collection of several photos. These may be actual photos of real persons whose likenesses are used to give true physical characteristics to the virtual guide. Some patients may find that they identify with or are drawn to a guide based upon physical appearance. The photo may also provide the patient with information related to the sex, approximate age and race of the guide, where this information is not provided within the written biographies or profiles of the virtual guides. Additionally, the photo may demonstrate a guide's ‘style’, through clothing preference and hairstyle, thereby making the virtual guide more realistic. In an alternative embodiment, the guide may be represented by a computer generated “picture” or through animation.

In one embodiment, the virtual guides are represented by a video clip. These are actual videos of real persons whose likenesses are used to give “life” to the virtual guides. The use of video clips and other similar media allows the patient to see and hear the guide in addition to receiving basic biographical information. A guide may have an accent, unique mannerisms and/or other characteristics would best be detected from a video clip or similar means.

The patient is able to choose his or her own virtual guide from whom they will receive encouragement and information. The patient may select a guide with whom he or she can identify or feel comfortable. The virtual guides are designed to invoke an emotional bond or connection with the program participants and should share or understand the patient's fears and anxieties. However, a patient may choose a virtual guide based on any number of alternative reasons.

Importantly, the virtual guide's role is to provide encouragement, not to serve as a replacement for the doctor or pharmacist. The guide-patient relationship is designed to break through isolation and longstanding psychological defenses of the patient. Customized e-mails are delivered to the patient in the style and tone of the guide that the patient has selected. The “style and tone” of the virtual guide is a composite of various characteristics such as the attitude of the guide, the guide's educational level, any regional dialect assigned to the guide, the language of the e-mail communications, or the age of the patient, etc. and is typically demonstrated by wording choice. These e-mails address areas beyond the physical needs of the patient and also address the personal, emotional aspects of the GI disease or disorder that the patient is diagnosed with. The virtual guides are designed to reflect a “fellow sufferer” diagnosed and experienced with the GI disease or disorder that the patient is afflicted with. The more-sophisticated virtual guide will describe, to the less-sophisticated patient, living and coping with the condition on a day-to-day basis. The discovery of shared experiences will help strengthen hope in the less-experienced patient and can firm a patient's resolve to focus on a condition and discover that it is manageable.

Although the above description contains many specificities, these should not be construed as limitations on the scope of the invention, but merely as illustrations of the presently described embodiment. Many other embodiments of the invention are possible. For example, the guide profiles, the patient e-mail and the patient-entered data need not be centrally located in one centralized database on one computer. In another embodiment the guide profiles, the patient e-mail and the patient-entered data may be saved on separate computers that are in different locations but are linked together via a remote network. Therefore, the scope of the invention should be determined, not by the examples given, but by the appended claims and their legal equivalents.

What is claimed is:

1. An on-line method for increasing patient compliance with a treatment regimen that is designed to treat, prevent, cure or alleviate gastrointestinal disorders or diseases comprising a patient-user afflicted with a gastrointestinal disease or disorder conducting the steps of:
(a) accessing a web page providing a selection of virtual guides with varying physical characteristics and personality traits from a remote interface via a remote network,
(b) selecting a virtual guide,
(c) inputting personal data, and
(d) receiving computer generated informational and motivational electronic messages composed in the style and tone of the virtual guide.

2. The method of clam 1 wherein electronic messages are sent to the patient according to predetermined frequency schedule based on the needs of the patient according to the personal data entered.

3. The method of claim 1 wherein the personal data is inputted via a forms-based questionnaire.

4. The method of claim 1 further comprising the step of inputting additional personal information after receiving one or more electronic messages containing additional forms-based questionnaires.

5. The method of claim 1 wherein the remote network is a public communication network

6. The method of claim 5 wherein the public communication network is the Internet.

7. The method of claim 1 wherein the remote interface is a personal computer.

8. The method of claim 1 wherein the gastrointestinal diseases and disorders are selected from the group consisting of gastroesophageal reflux disease (GERD), inflammatory bowel disease (IBD), irritable bowel syndrome (IBS), ulcerative colitis (UC), Peptic Ulcer Disease, gastric cancer, colon cancer, dysphagia, heartburn, constipation, diarrhea, diverticulitis, diverticulosis, Crohn's disease, achalasia, intestinal lactase deficiency, Zollinger-Ellison syndrome, esophagitis, polyps, and dysplasia.

9. The method of claim 8 wherein the gastrointestinal diseases and disorders are selected from the group consisting of inflammatory bowel disorder, irritable bowel syndrome, ulcerative colitis and Crohn's disease.

10. An automated, on-line method for increasing patient compliance with a treatment regimen that is designed to treat, prevent, cure or alleviate gastrointestinal disorders and diseases comprising the steps of:
(a) providing a web page for a patient to access from a remote interface via a remote network wherein the patient is prompted to choose a virtual guide from a selection of virtual guides,
(b) transferring to the patient a forms-based questionnaire wherein the patient is requested to submit personal data,
(c) generating an informational and motivational electronic message composed in the style and tone of the patient's selected virtual guide, and
(d) transferring the electronic message to the patient.

11. The method of claim 10 wherein the remote network is a public communication network.

12. The method of claim 11 wherein the public communication network is the Internet.

13. The method of claim 10 wherein the remote interface is a personal computer.

14. The method of claim 10 wherein the gastrointestinal diseases and disorders are selected from the group consisting of gastroesophageal reflux disease (GERD), inflammatory bowel disease (IBD), irritable bowel syndrome (IBS), ulcerative colitis (UC), Peptic Ulcer Disease, gastric cancer, colon cancer, dysphagia, heartburn, constipation, diarrhea, diverticulitis, diverticulosis, Crohn's disease, achalasia, intestinal lactase deficiency, Zollinger-Ellison syndrome, esophagitis, polyps, and dysplasia.

15. The method of claim 14 wherein the gastrointestinal diseases and disorders are selected from the group consisting of inflammatory bowel disorder, irritable bowel syndrome, ulcerative colitis and Crohn's disease.

16. An automated, on-line method for increasing patient compliance with a treatment regimen that is designed to treat, prevent, cure or alleviate gastrointestinal disorders and diseases comprising the steps of:
(a) storing virtual guide profiles in a centralized database, housed on a database server, for access by a patient-user from a remote interface via a remote network,
(b) transferring virtual guide profiles to a remote interface for review by the patient-user,
(c) receiving a virtual guide selection made by the patient-user,
(d) generating one or more electronic messages wherein the electronic message is composed in the style and tone of the selected virtual guide, and
(e) transferring one or more electronic messages to the patient-user.

17. The method of claim 16 wherein the remote network is a public communication network.

18. The method of claim 17 wherein the public communication network is the Internet.

19. The method of claim 16 wherein the remote interface is a personal computer.

20. The method of claim 16 wherein the gastrointestinal diseases and disorders are selected from the group consisting of gastroesophageal reflux disease (GERD), inflammatory bowel disease (IBD), irritable bowel syndrome (IBS), ulcerative colitis (UC), Peptic Ulcer Disease, gastric cancer, colon cancer, dysphagia, heartburn, constipation, diarrhea, diverticulitis, diverticulosis, Crohn's disease, achalasia, intestinal lactase deficiency, Zollinger-Ellison syndrome, esophagitis, polyps, and dysplasia.

21. The method of claim 20 wherein the gastrointestinal diseases and disorders are selected from the group consisting of inflammatory bowel disorder, irritable bowel syndrome, ulcerative colitis and Crohn's disease.

22. An automated, on-line method for increasing patient compliance with a treatment regimen that is designed to treat, prevent, cure or alleviate gastrointestinal disorders and diseases comprising the steps of:
(a) storing virtual guide profiles in a centralized database, housed on a database server, for access by a patient-user from a remote interface via a remote network,
(b) transferring virtual guide profiles to the remote interface for review by the patient-user,
(c) receiving a patient-user's selection of a virtual guide,
(d) transferring to the patient-user a forms-based questionnaire containing questions for determining a patient-user's personality type and frequency schedule for electronic messages to be sent to the patient-user,
(e) receiving answers to the forms-based questionnaire entered by the patient-user,
(f) storing the answers to the forms-based questionnaire in the centralized database,
(g) evaluating the answers to the forms-based questionnaire and comparing the answers to a personality matrix to determine the personality type of the patient-user,
(h) evaluating the answers to the forms-based questionnaire and comparing the answers to a frequency matrix to determine the appropriate frequency schedule for sending electronic messages to the patient-user,
(i) generating one or more electronic messages wherein the electronic message is in the voice, tone and style of the selected virtual guide and the content is based on the answers to the forms-based questionnaire,
(j) transferring one or more electronic messages to the patient-user, and
(k) storing the electronic message content in the centralized database.

23. The method of claim 22 wherein the remote network is a public communication network.

24. The method of claim 23 wherein the public communication network is the Internet.

25. The method of claim 22 wherein the remote interface is a personal computer.

26. The method of claim 22 wherein the electronic message contains a forms-based questionnaire containing additional questions for further customization of electronic messages.

27. The method of claim 22 wherein the gastrointestinal diseases and disorders are selected from the group consisting of gastroesophageal reflux disease (GERD), inflammatory bowel disease (IBD), irritable bowel syndrome (IBS), ulcerative colitis (UC), Peptic Ulcer Disease, gastric cancer, colon cancer, dysphagia, heartburn, constipation, diarrhea, diverticulitis, diverticulosis, Crohn's disease, achalasia, intestinal lactase deficiency, Zollinger-Ellison syndrome, esophagitis, polyps, and dysplasia.

28. The method of claim 27 wherein the gastrointestinal diseases and disorders are selected from the group consisting of inflammatory bowel disorder, irritable bowel syndrome, ulcerative colitis and Crohn's disease.
